(19) United States
(12) Patent Application Publication
(10) Pub. No.: US 2025/0036264 A1
(43) Pub. Date: Jan. 30, 2025

(54) NETWORK STATUS VISUALIZATION FOR MONITORING AND CONFIGURATION

(71) Applicant: VMware LLC., Palo Alto, CA (US)

(72) Inventors: Omkar KHADAMKAR, Pune (IN); Pavan VAIDYULA, Pune (IN); Shrinivas Sharad PARASHAR, Pune (IN); Priyanka BALI, Pune (IN)

(21) Appl. No.: 18/378,689

(22) Filed: Oct. 11, 2023

(30) Foreign Application Priority Data
Jul. 24, 2023 (IN) 202341049837

(51) Int. Cl. G06F 3/0484; G06F 3/0482; G06F 3/16; H04L 43/045

(52) U.S. Cl. CPC G06F 3/0484; G06F 3/0482; G06F 3/167; H04L 43/045

(57) ABSTRACT

Example methods and systems for network status visualization are described. In one example, a computer system may obtain status information associated with a set of multiple object-attribute pairs. Each object-attribute pair may include one of multiple objects and one of multiple attributes. The computer system may generate and display a user interface (UI) view that includes an array of multiple interactive UI elements to display the status information. In response to detecting a first interaction with a first interactive UI element, the computer system may update the UI view to display and enable selection of a first action. In response to detecting a second interaction with a second interactive UI element, the computer system may update the UI view to display and enable selection of a second action.

### RELATED APPLICATIONS

Benefit is claimed under 35 U.S.C. 119 (a)-(d) to Foreign application Ser. No. 20/2341049837 filed in India entitled “NETWORK STATUS VISUALIZATION FOR MONITORING AND CONFIGURATION”, on Jul. 24, 2023, by VMware, Inc., which is herein incorporated in its entirety by reference for all purposes.

### BACKGROUND

Virtualization allows the abstraction and pooling of hardware resources to support virtual machines in a software-defined networking (SDN) environment, such as a software-defined data center (SDDC). For example, through server virtualization, virtual machines (VMs) running different operating systems may be supported by the same physical machine (also referred to as a “host”). Each VM is generally provisioned with virtual resources to run an operating system and applications. The virtual resources may include central processing unit (CPU) resources, memory resources, storage resources, network resources, etc. Through virtualization of networking services, logical network elements may be deployed to provide logical connectivity among VMs or other virtualized computing instances. In practice, it is desirable to provide a visualization of various entities in the SDDC to facilitate network monitoring and configuration.

### BRIEF DESCRIPTION OF DRAWINGS

FIG. 1 is a schematic diagram illustrating an example system architecture for network status visualization for monitoring and configuration;

FIG. 2 is a schematic diagram illustrating example user interface (UI) view for network status visualization;

FIG. 3 is a flowchart of an example process for a computer system to perform network status visualization for monitoring and configuration;

FIG. 4 is a schematic diagram illustrating a first example user interface (UI) view for network status visualization;

FIG. 5 is a schematic diagram illustrating a second example UI view that is generated and displayed in response to detecting a first hover interaction in the example in FIG. 4;

FIG. 6 is a schematic diagram illustrating a third example UI view that is generated and displayed in response to detecting a second hover interaction in the example in FIG. 4;

FIG. 7 is a schematic diagram illustrating a fourth example UI view to facilitate configuration for an object-attribute pair;

FIG. 8 is a schematic diagram illustrating a fifth example UI view to facilitate bulk configuration for multiple objects and/or multiple attributes; and

FIG. 9 is a schematic diagram illustrating an example software-defined networking (SDN) environment for which network status visualization for monitoring and configuration may be performed.

### DETAILED DESCRIPTION

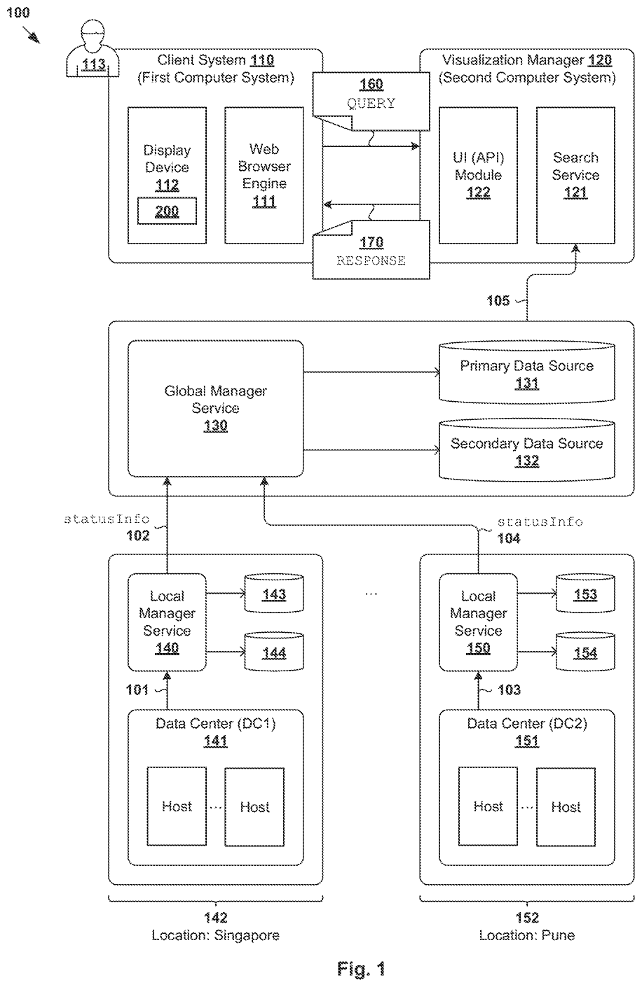

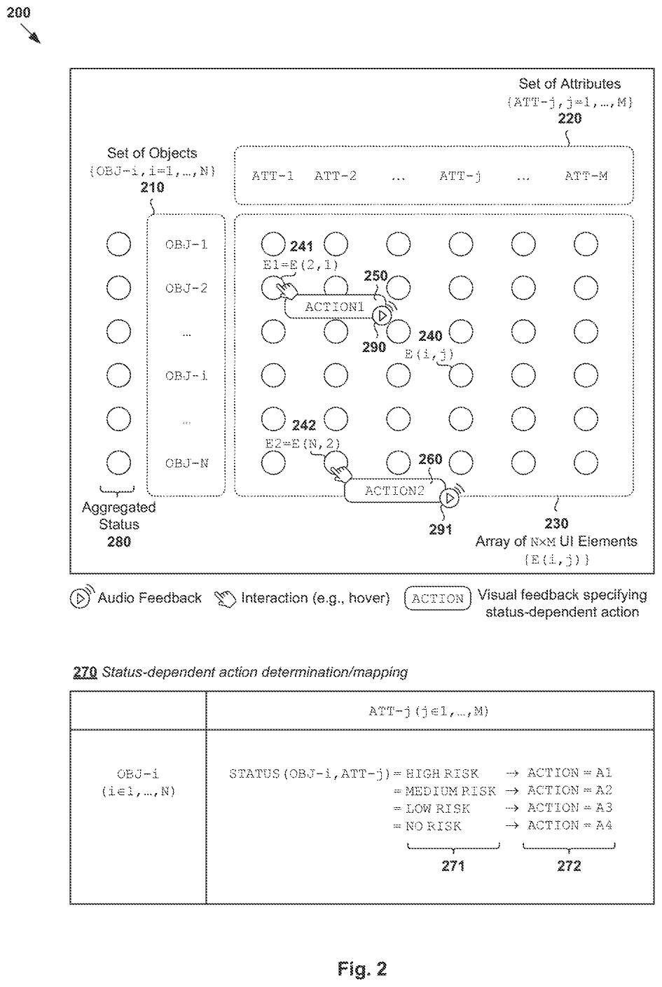

According to examples of the present disclosure, network status visualization may be performed in an improved manner to facilitate network monitoring and configuration. One example may involve a computer system (e.g., client system 110 in FIG. 1) obtaining status information associated with a set of multiple object-attribute pairs. Each object-attribute pair may include one of multiple objects (see 210 in FIG. 2) in a network environment, and one of multiple attributes (see 220 in FIG. 2) associated with the multiple objects. The computer system may generate and display, on a display device, a user interface (UI) view that includes an array of multiple interactive UI elements (see 230 in FIG. 2) to display the status information associated with respective multiple object-attribute pairs.

In response to detecting a first interaction with a first interactive UI element (see 240 in FIG. 2) from the array, the computer system may update the UI view to display and allow selection of a first action (see 250 in FIG. 2). Here, (a) the first interactive UI element may be associated with a first object-attribute pair from the set, and (b) the first action may be determined based on first status information associated with the first object-attribute pair. In response to detecting a second interaction with a second interactive UI element (see 241 in FIG. 2) from the array, the computer system may update the UI view to display and allow selection of a second action (see 260 in FIG. 2). Here, (a) the second interactive UI element may be associated with a second object-attribute pair from the set, and (b) the second action may be determined based on second status information associated with the second object-attribute pair.

In at least some embodiments, examples of the present disclosure may be implemented to reduce cognitive load on users and improve efficiency during network monitoring and configuration. Examples of the present disclosure should be contrasted against conventional dashboard or summary view that shows the status of entities or objects in a network environment. In this case, the status of an object is often shown as an aggregation of multiple attributes. To get more detailed information about a particular attribute, users are generally required to drill down from the summary view to specific attribute views for one entity at a time. The users may also have to switch between multiple views to ensure that they are making the right decision. To reduce the likelihood of cognitive overload associated with long scrolling, drilling down and switching views, examples of the present disclosure may be implemented to provide status information associated with multiple object-attribute pairs using an array of interactive UI elements in a single UI view.

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the drawings, can be arranged, substituted, combined, and designed in a wide variety of different configurations, all of which are explicitly contemplated herein. Although the terms “first” and “second” are used throughout the present disclosure to describe various elements, these elements should not be limited by these terms. These terms are used to distinguish one element from another. For example, a first element may be referred to as a second element, and vice versa.

### Example System Architecture

FIG. 1 is a schematic diagram illustrating example system architecture 100 to implement network status visualization for monitoring and configuration. It should be understood that, depending on the desired implementation, example system architecture 100 may include additional and/or alternative components than that shown in FIG. 1. Example system architecture 100 may include client system 110 (“first computer system”) and visualization manager 120 (“second computer system”) in communication with each other to implement network status visualization to facilitate monitoring and configuration, etc. Client system 110 may be operated by any suitable user 113, such as a network administrator responsible for network monitoring, configuration and troubleshooting, etc.

Depending on the desired implementation, client system 110 and visualization manager 120 may each include any suitable hardware and/or software components. In the example in FIG. 1, visualization manager 120 may include user interface (UI) module 122 to interact with client system 110, search service 121 to handle queries from client system 110 and generate responses, etc. Client system 110 may include web browser engine 111 to interact with UI module 122 and generate graphical UI views, display device 112 to display UI views and detect interaction of user 113 with various UI element(s), etc. UI module 122 may facilitate interaction with client system 110 via any suitable interface(s), such as representational state transfer (REST) application programming interface (API), etc.

As used herein, the term “UI” or “UI view” may refer generally to a set of UI elements that may be generated and displayed on a display device. The term “UI element” may refer generally to graphical (i.e., visual) and/or textual element that may be displayed on display device 112, such as shape (e.g., circle, rectangle, ellipse, polygon, line, etc.), window, modal, panel or pane, button, check box, menu, dropdown box, editable grid, section, slider, text box, text block, toggle switch (on/off button), or any combination thereof. UI views may be displayed side by side, or nested inside of each other to create more complex layouts.

In the example in FIG. 1, visualization manager 120 may be configured to access status information (denoted as statusInfo) collected using various entities, such as global manager 130 and multiple local managers 140-150 (two shown for simplicity). For example, first local manager 140 may be configured to manage network and security services for first data center (DC1) 141 at first geographical location 142 (e.g., Singapore). Second local manager 150 may be configured to manage network and security services for second data center (DC2) 151 at second geographical location 152 (e.g., Pune). Global manager 130 may be configured to federate multiple local managers 140-150.

At 101-102 in FIG. 1, first local manager 140 may obtain status information associated with first data center 141 and report the status information to global manager 130. Similarly, at 103-104, second local manager 150 may obtain status information associated with second data center 142 and report the status information to global manager 130. The status information may be collected by each local manager 140/150 any suitable sampling rate and pushed towards global manager 130 for storage in primary and/or secondary database(s) 131-132. Databases (see 131-132, 143-144, 153-154) accessible by manager 130/140/150 may be implemented using any suitable technology, such as OpenSearch, Corfu, etc.

Depending on the desired implementation, search service 121 on visualization manager 120 may maintain indexed information and synchronized the indexed information with the information in database 131/132 associated with global manager 130. This way, based on the indexed information, search service 121 may access database 131/132 (see 105) to handle queries (see 160) for any information required by client system 110 to generate/render UI views. In particular, based on a response (see 170) from search service 121, web browser engine 111 may generate and display UI views on display device 112 of client system 110.

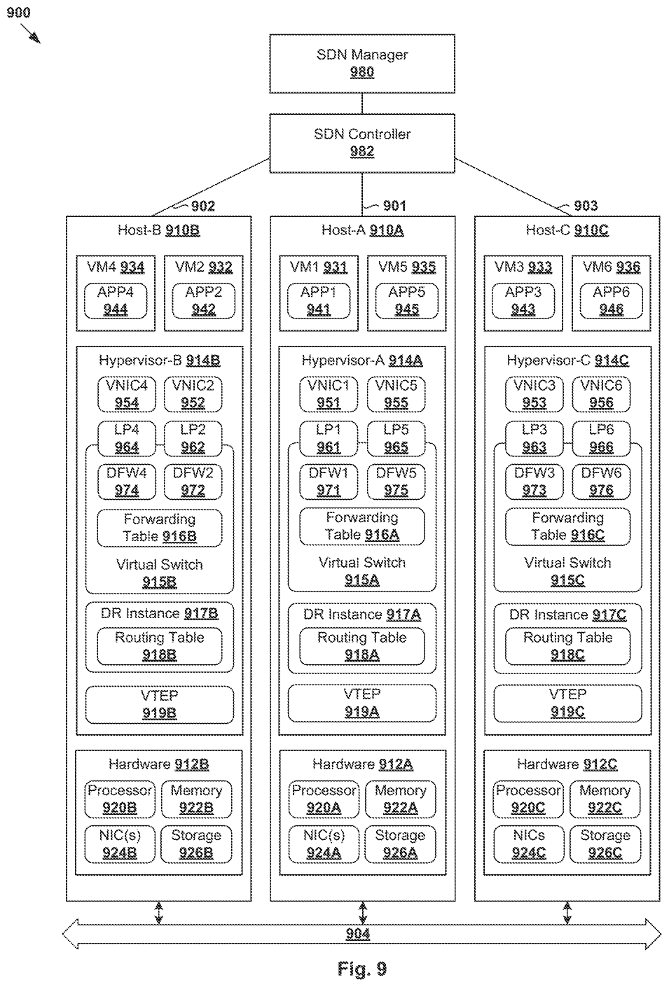

As used herein, the term “entity” or “object” (also referred to as “managed object” or “managed inventory object”) may refer generally to a virtual or physical object in a network environment. In the example in FIG. 1, example objects may include global manager 130, local managers 140-150, data centers at different geographical locations (e.g., see 141-142 and 151-152), clusters, sub-clusters, hosts, virtualized computing instances, datastores, networks, resource pools, etc. A “cluster” may refer generally to a collection of hosts and associated VMs intended to work together as a unit. When a host is added to a cluster, the host's resources become part of the cluster's resources. A “sub-cluster” may refer generally to a subset of hosts within a cluster. A “host” or “transport node” may refer generally to a physical computer system supporting virtualized computing instances, such as virtual machines (VMs) or containers. Example hosts in a particular data center will be explained using FIG. 9.

In practice, web browser engine 111 may be capable of detecting a user's interaction on any UI element(s) on UI view(s) displayed on display device 112, such as mouse click(s), keyboard input(s), finger gesture(s) on a touch screen, etc. Web browser engine 111 may include a layout and rendering engine to render/generate/paint UI views on display device 112 based on response(s) from visualization manager 120, such as by interpreting hypertext transfer markup language (HTML) and/or extensible markup language (XML) documents along with images, etc. For example, web browser engine 111 may parse HTML documents and build a document object model (DOM) to represent content of a web page or UI view in a tree-like structure.

Conventionally, one approach is to provide network status visualization associated with global and local managers 130-150 in the form of cards, such as a first card for first local manager 140, a second card for second local manager 150 and a third card for global manager 130. Each card is designed to present a status that is aggregated from multiple attributes associated with manager 130/140/150. In this case, users (e.g., enterprise administrators) would have to switch between multiple views to get more details about each specific attribute. Also, since each card would usually encroach more space, this may lead to a long scroll to view status information associated with a large number of global and local managers.

### Network Status Visualization for Monitoring and Configuration

According to examples of the present disclosure, network status visualization may be implemented in an improved manner, such as to reduce cognitive burden on users and improve efficiency by reducing the amount of long scrolling and/or context switching during network monitoring and configuration. In practice, it is important for enterprise administrators to be able to perform network monitoring and configuration efficiently to maintain healthy network and security infrastructure. In at least some embodiments, examples of the present disclosure may provide an efficient way to detect and remediate risks, as well as to perform configuration with substantially minimal clicks.

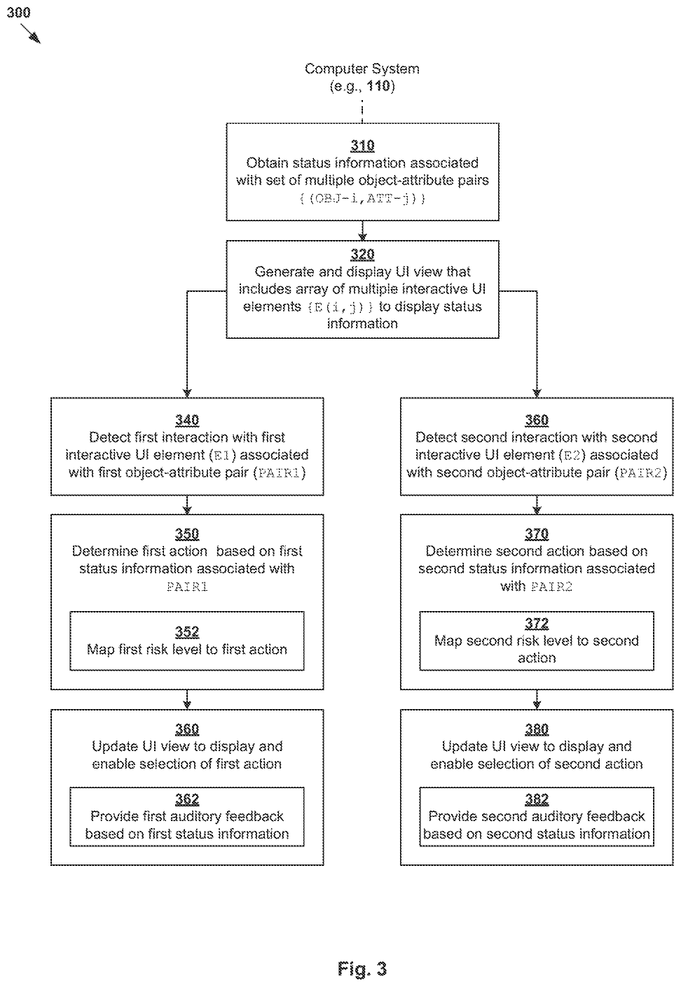

In more detail, some examples will be explained using FIGS. 2-3. Here, FIG. 2 is a schematic diagram illustrating example UI view 200 for network status visualization. FIG. 3 is a flowchart of example process 300 for a computer system to provide network status visualization for monitoring and configuration. Example process 300 may include one or more operations, functions, or actions illustrated by one or more blocks, such as 310 to 380. The various blocks may be combined into fewer blocks, divided into additional blocks, and/or eliminated depending on the desired implementation.

Examples of the present disclosure may be performed using any suitable computer system(s) that include hardware and/or software components configured to provide network status visualization for monitoring and configuration. Example process 300 may be implemented using client system 110 as a first computer system, and visualization manager 120 as a second computer system. In the following, client system 110 (e.g., web browser engine 111) may generate and send queries towards visualization manager 120 (e.g., search service 121 via UI module 122). Based on responses from visualization manager 120, client system 110 (e.g., web browser engine 111) may generate and display UI view(s) on display device 112.

At 310 in FIG. 3, client system 110 may obtain status information associated with a set of multiple object-attribute pairs from visualization manager 120. For example in FIG. 2, at 210, a first set of multiple (N) objects of interest in network environment 100 may be denoted as {OBJ-i}, where i=1, . . . , N. At 220, a second set of multiple (M) attributes or parameters associated with each object in the first set may be denoted as {ATT-j}, where j=1, . . . , M. Based on first set 210 and second set 220, the set of multiple (N×M) object-attribute pairs may be denoted as {(OBJ-i, ATT-j)} for i=1, . . . , N and j=1, . . . , M. A particular object-attribute pair denoted as (OBJ-i, ATT-j) includes OBJ-i from first set 210 and ATT-j from second set 220, where i∈1, . . . , N and j∈1, . . . , M. Note that first set 210 and second set 220 may be user configurable.

At 320 in FIG. 3, client system 110 may generate and display, on display device 112, a UI view that includes an array of multiple interactive UI elements to display the status information associated with respective multiple object-attribute pairs. For example in FIG. 2, at 230, the array may include multiple (N×M) interactive UI elements denoted as {E(i, j)} for i=1, . . . , N and j=1, . . . , M. At 240 in FIG. 2, a particular interactive UI element denoted as E(i, j) may be configured to display status information associated with pair=(OBJ-i, ATT-j).

At 330 in FIG. 3, client system 110 may detect a first interaction with a first interactive UI element from array 230, such as E(2,1) for first pair=(OBJ-2, ATT-1) at 241 in FIG. 2. In response, at 340-350, client system 110 may determine a first action based on first status information associated with first pair=(OBJ-2, ATT-1); and update the UI view to display and allow selection (e.g., click to select) of the first action; see 250 in FIG. 2.

At 360 in FIG. 3, client system 110 may detect a second interaction with a second interactive UI element from array 230, such as E(N, 2) for second pair=(OBJ-N, ATT-2) at 242 in FIG. 2. In response, at 370-380, client system 110 may determine a second action based on second status information associated with second pair=(OBJ-N, ATT-2); and update the UI view to display and allow selection of the second action; see 260 in FIG. 2.

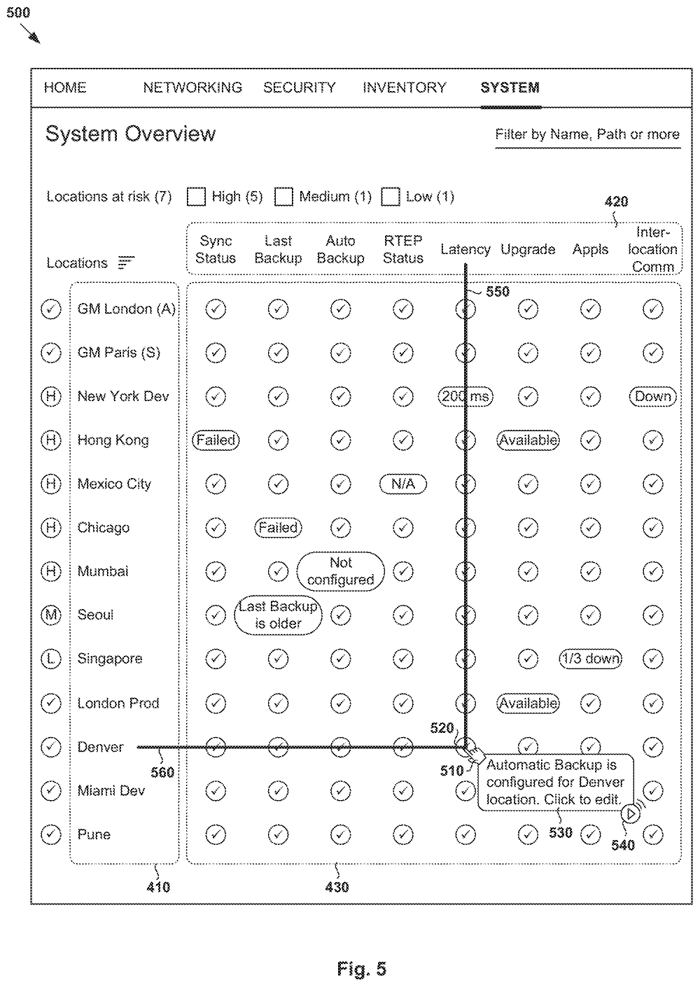

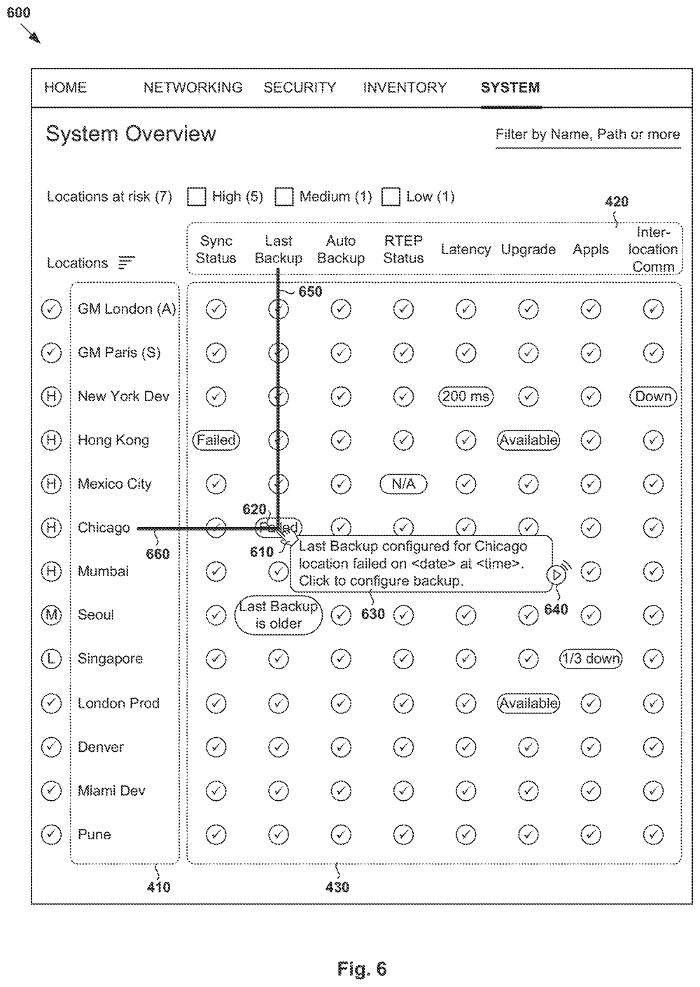

Depending on the desired implementation, the term “status information” may refer to any suitable a value of attribute=ATT-j for object=OBJ-i, or a derived value that is calculated based on (i.e., derived from) the value of attribute=ATT-j for object=OBJ-i. At 270 in FIG. 2, status information denoted as STATUS (OBJ-i, ATT-j) may be derived based on a risk level associated with a particular object-attribute pair. Example risk levels (see 271) may include high risk, medium risk, low risk and no risk (healthy). In this case, block 350/370 may involve dynamically mapping status information=risk level to a corresponding status-dependent action for displayed on UI view 200 for review and selection by user 113; see 272 in FIGS. 2 and 352/372 in FIG. 3. This way, examples of the present disclosure may provide user 113 with a quicker way of detecting and remediating risk(s) as well as initiating action(s) to configure workflow(s) with substantially minimal clicks. Some examples will be described using FIGS. 5-6.

Example UI view 200 in FIG. 2 may also be referred to as a “fretboard view.” In particular, using array of interactive UI elements 230, status information associated with multiple object-attribute pairs may be displayed in a single UI view. The fretboard view is designed to reduce, if not avoid, the need for user 113 to perform long scrolling and switch between multiple UI views to obtain the status information. In practice, example UI view 200 in FIG. 2 may be generated to further include aggregated status information (see 280). The aggregated status information for each object-attribute pair may be calculated based on an aggregation of all status information for OBJ-i, i.e., STATUS (OBJ-i, ATT-1, . . . , ATT-M). In this case, the same UI view 200 may be generated to visualize all attributes contributing to an aggregated status, as well as the aggregated status itself. This helps user 113 to reduce cognitive burden, navigational clicks and time during network monitoring and configuration.

### Example Fretboard View

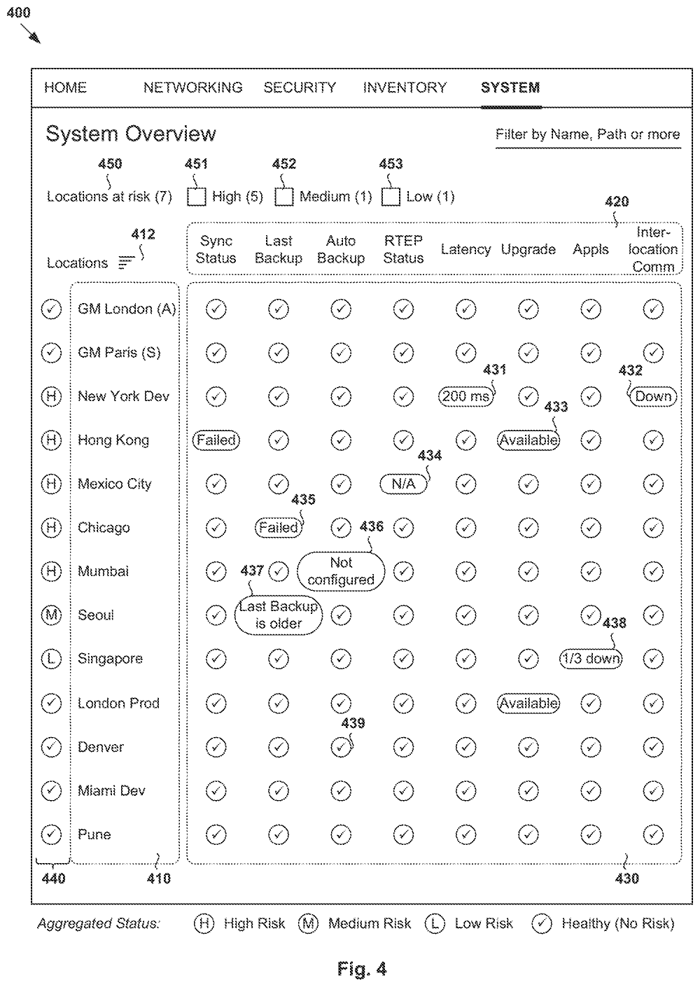

FIG. 4 is a schematic diagram illustrating first example UI view 400 for network status visualization for monitoring and configuration. First UI view 400 may represent a default state of a fretboard view for the example in FIG. 1. Client system 110 may generate and display first UI view 400 that includes the following UI elements based on a query response from visualization manager 120 in reply to a query from client system 110 (see 150-160 in FIG. 1). In this example, the query response may include status information associated with a first set of multiple objects in the form of global managers and data centers, and a second set of attributes. The query response may also include status information associated with each object-attribute pair, as well as any additional information identifying status-dependent action(s) associated with the status information. In practice, API module 122 and/or search service 121 may aggregate status information for different objects. A query from client system 110 may include parameter(s) for filtering the response, such as all locations that have at least one attribute associated with a particular risk level (e.g., high risk), etc.

### (a) Customizable First Header Information

At 410 in FIG. 4, first UI view 400 may be generated to include first header information (e.g., left headers) that lists a first set of multiple (N) objects denoted as {OBJ-i, i=1, . . . , N} to user 113. Using N=13 as an example, the first set may include a cluster of global managers (e.g., “GM London” in active (A) mode and “GM Paris” in standby(S) mode) and various data center locations (e.g., “Hong Kong,” “Singapore” and “Pune”). The left headers may have categorical titles. User 113 may sort the list of left headers using a “sort” icon option (412) placed next to the “Locations” title. First UI view 400 may be generated to enable modification of first header information 410, such as adding or removing a particular object (OBJ-i)=data center location of interest by checking or unchecking an associated checkbox.

### (b) Customizable Second Header Information

At 420 in FIG. 4, first UI view 400 may be generated to include second header information (e.g., top headers) that lists a second set of attributes denoted as {ATT-j, j=1, . . . , M} to user 113. Using M=8 as an example, example attributes include ATT-1=Sync Status, ATT-2=Last Backup, ATT-3=Automatic Backup, ATT-4=remote tunnel endpoint (RTEP) Status, ATT-5=Latency, ATT-6=Upgrade, ATT-7=Appliances (“Appls” for brevity) and ATT-8=Inter-location Communication. These attributes may represent health parameters associated with each object listed by left headers 410. First UI view 400 may be generated to enable modification of second header information 420, such as adding or removing a particular attribute (ATT-j) interest by checking or unchecking an associated checkbox.

### (c) Array of Interactive UI Elements

At 430 in FIG. 4, first UI view 400 may be generated to include an array of interactive UI elements (also known as nodal or status points) to display status information associated with each pair of (OBJ-i, ATT-j). As explained using FIG. 2, the array may include multiple (N×M) interactive UI elements denoted as {E(i,j)} for i=1, . . . , N and j=1, . . . , M. A particular interactive UI element E(i,j) may be configured to display status information associated with a particular pair=(OBJ-i, ATT-j).

For example, each interactive UI element E(i,j) may include a dot or pill-shaped label to indicate a risk level of OBJ-i in relation to ATT-j. Example risk levels include H=high risk, M=medium risk, L=low risk and no risk (i.e., healthy). The risk levels may be indicated on example UI view 400 using any suitable colors (e.g., green dot for no risk, grey dot for “L,” yellow dot for “M” and red dot for “L”), symbols or letters (e.g., “H,” “M,” “L” and tick for no risk), etc. If a particular pair=(OBJ-i, ATT-j) is associated with status information=high, medium or low risk, its interactive UI element E (i, j) on first UI view 400 may be configured to provide a brief description or snapshot of the status information. This is to help user 113 to pinpoint the exact issue(s) to facilitate network troubleshooting and remediate problems with fewer clicks.

Some examples will be explained using 431-438. First UI element 431 may specify “200 ms” (i.e., high risk) associated with OBJ-i=New York Dev and ATT-j=Latency. Second UI element 432 may specify “Down” (i.e., high risk) associated with OBJ-i=New York Dev and ATT-j=Inter-location communication. Third UI element 433 may specify “Available” (i.e., high risk) associated with OBJ-i=Hong Kong and ATT-j=Upgrade. Fourth UI element 434 may specify “N/A” (i.e., RTEP status not available indicating high risk) associated with OBJ-i=Mexico City and ATT-j=RTEP status.

Fifth UI element 435 may specify “Failed” (i.e., high risk) associated with OBJ-i=Chicago and ATT-j=Last Backup. Sixth UI element 436 may specify “Not configured” (i.e., high risk) associated with OBJ-i=Mumbai and ATT-j=Automatic Backup. Seventh UI element 437 may specify “Last backup is older” (i.e., medium risk) associated with OBJ-i=Seoul and ATT-j=Last Backup. Eighth UI element 438 may specify “1 out of 3 down” (i.e., low risk) associated with OBJ-i-Singapore and ATT-j=Appliances. Ninth UI element 439 may be in the form of a green dot with a tick (i.e., no risk) associated with OBJ-i=Denver and ATT-j=Automatic Backup. This way, UI view 400 may provide a correlation of all objects with the status of various attributes in a single view.

### (d) Aggregated Status Information

At 440 in FIG. 4, first UI view 400 may be generated to display aggregated status information associated with each object (OBJ-i). The aggregated status information may be indicated using rolled-up status indicators associated with respective objects. In the example in FIG. 4, each indicator may be placed substantially adjacent to the name of a global manager or data center location to indicate an aggregated status associated with that global manager or location. The aggregated status may indicate an overall risk level associated with the global manager or location based on all attributes, such as H=high risk, M=medium risk, L=low risk and no risk (i.e., healthy). Similarly, the aggregated risk level may be indicated using any suitable colors (e.g., green dot for no risk, grey dot for “L,” yellow dot for “M” and red dot for “L”), symbols or letters (e.g., “H,” “M,” “L” and tick for no risk), etc.

### (e) Filtering

At 450 in FIG. 4, first UI view 400 may be generated to include a filtering option above first header information 410 to enable user 113 to select object(s) associated with a particular risk severity level for display. For example, first checkbox filter may be selected to display object(s) associated with risk severity level=“High,” second filter to select “Medium,” and third filter to select “Low.” See 451-453.

It should be understood that example UI view 400 may be adapted according to the different scales of objects or entities in a network environment. When fewer objects and/or attributes are shown compared to the example in FIG. 4, the fretboard view or visualization may be sparser or scattered. When more objects and/or attributes are shown compared to the example in FIG. 4, a corresponding array of UI elements may be presented in a denser manner. When they cannot be accommodated by the screen resolution, approaches such as lazy loading or pagination may be leveraged.

### Example Hover Interactions

In response to detecting an interaction with UI element=E(i,j) for pair=(OBJ-i, ATT-j), client system 110 may update first UI view 400 in FIG. 4 to display visual feedback (e.g., tooltip) substantially adjacent to the UI element to provide additional details associated with status information=STATUS (i, j) and an action that may be performed. As used herein, the term “tooltip” may refer generally to a message or extra information that appears in response to detecting a user's interaction with an interactive UI element.

Example interactions may include mouse-hover gesture, keyboard-hover gesture, finger gesture (e.g., tapping and holding) on a touch panel of display device 112, etc. Some examples will be described using FIGS. 5-6. Depending on the desired implementation, any information required to generate the visual feedback (e.g., tooltip) and/or auditory feedback associated with STATUS (i, j) in FIGS. 5-6 may be included in an initial query response from visualization manager 120, where the example in FIG. 4 is generated based on the initial query response. Alternatively or additionally, the tooltip may be generated based on any subsequent query response from visualization manager 120.

### (a) First Example

FIG. 5 is a schematic diagram illustrating second example UI view 500 that is generated and displayed in response to detecting a first hover interaction in the example in FIG. 4. In this example, client system 110 may detect hover interaction 510 over UI element E(i,j) 520 associated with the (OBJ-i=Denver, ATT-j=Automatic Backup) pair.

At 530 in FIG. 5, in response to detecting first hover interaction 510, client system 110 may update UI view 400 in FIG. 4 to generate updated UI view 500 in FIG. 5. Here, updated UI view 500 is generated to include a tooltip substantially adjacent to UI element 520 to display message=“<ATT-j=Automatic backup> is configured for <OBJ-i=Denver> location. Click to edit.” This is to explain that automatic backup is already configured and may be edited if desired. Note that tooltip 530 and possible status-dependent action=“edit” are determined and generated based on status information=no risk and the (OBJ-i=Denver, ATT-j=Automatic Backup) pair.

At 540 in FIG. 5, client system 110 may further generate updated UI view 500 to provide audio feedback along with tooltip 530 to deliver a more intuitive experience to user 113. This may involve (a) retrieving or selecting sound clip(s) configured for the status information associated with the (OBJ-i=Denver, ATT-j=Automatic Backup) pair and (b) playing the sound clip(s) as audio feedback. The sound clip(s) may be of any suitable duration (e.g., microseconds). For example, sound clip(s) associated with status information=high risk may have a substantially sharp quality to indicate the unhealthy status and to grab the attention of user 113. On the contrary, status information=no risk may have a substantially melodic quality to indicate the healthy status. User 113 may enable or disable the audio feedback via UI view 500.

At 550-560 in FIG. 5, updated UI view 500 may be generated to include a substantially vertical line connecting UI element 520 with OBJ-i=Denver and a substantially horizontal line connecting UI element 520 to ATT-j=Automatic Backup. This is to highlight the correlation of UI element 520 with OBJ-i=Denver and ATT-j=Automatic Backup.

### (b) Second Example

FIG. 6 is a schematic diagram illustrating third example UI view 600 that is generated and displayed in response to detecting a second hover interaction in the example in FIG. 4. In this example, client system 110 may detect hover interaction 610 over UI element E(i,j) 620 associated with the (OBJ-i=Chicago, ATT-j=Last Backup) pair in the example in FIG. 4.

At 630 in FIG. 6, in response to detecting second hover interaction 610, client system 110 may update UI view 400 in FIG. 4 to generate updated UI view 600 in FIG. 6 to include a tooltip to display message=“<ATT-j=Last backup> of <OBJ-i=Denver> location was failed on <date> at <time>. Click to configure backup.” Here, tooltip 630 and status-dependent action=“configure backup” are determined and generated based on status information=high risk and the (OBJ-i=Chicago, ATT-j=Last Backup) pair.

At 640 in FIG. 6, client system 110 may further generate updated UI view 600 to provide audio feedback along with tooltip 630. This may involve (a) retrieving or selecting sound clip(s) configured for the status information associated with the (OBJ-i=Chicago, ATT-j=Last Backup) pair and (b) playing the sound clip to provide audio feedback. In the example in FIG. 6, sound clip(s) associated with status information=high risk may have a substantially sharp quality compared to the example in FIG. 5.

At 650-660 in FIG. 6, updated UI view 600 may be generated to include a substantially vertical line and a substantially horizontal line from UI element 620 to highlight the correlation of UI element 620 with OBJ-i=Chicago and ATT-j=Last Backup.

In practice, colors used for the foreground elements such as text, severity indication, nodal point (i.e., UI element) and header connecting lines may be configured based on the World Wide Web Consortium (W3C) accessibility standard using approved contrast ratio with the background color. With the use of text weight and text size, the visual hierarchy may be maintained to distinguish the headers from the content on the nodal points. The focus and hover states may use higher contrasting colors to differentiate UI elements on the hover and on focus. The UI elements may respond to the different screen resolutions and zoom levels by reducing and increasing the column and rows in the viewable area. Examples of the present disclosure may be implemented to be accessible using keyboard tabs, arrow keys and assistive devices, as the focus switches from one nodal point to the next intentional nodal point by pressing directional keys.

### Configuration Actions

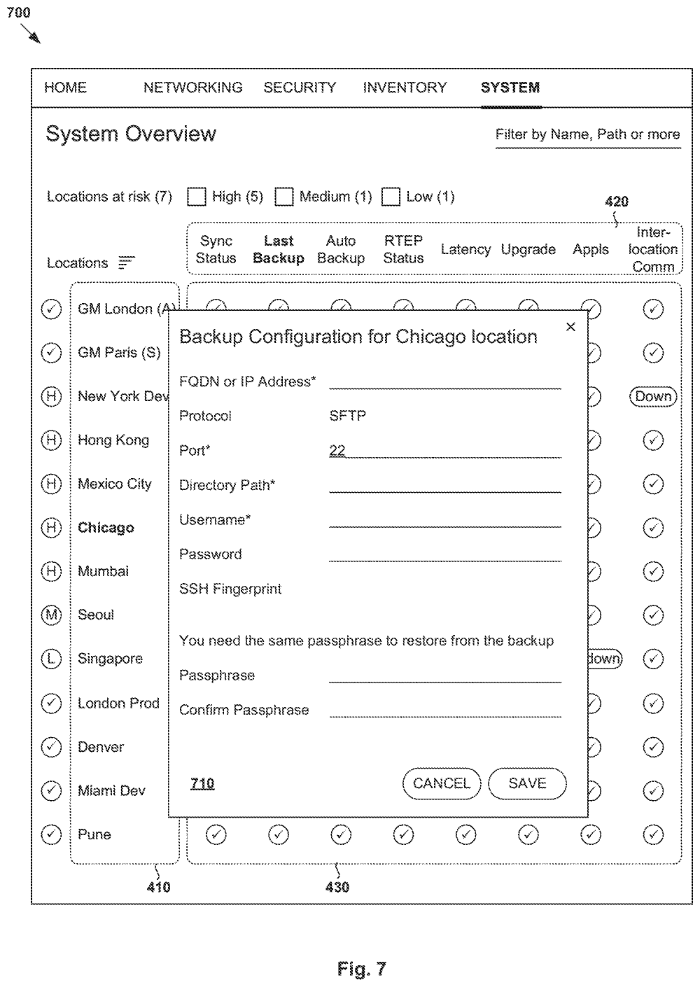

FIG. 7 is a schematic diagram illustrating fourth example UI view 700 to facilitate configuration for an object-attribute pair. In response to detecting a click interaction on UI element=E(i,j) or tooltip associated with E(i,j), client system 110 (e.g., web browser engine 111) may update an UI view to include a modal or panel to facilitate configuration of a particular action for pair=(OBJ-i, ATT-j). In practice, the term “modal” or “modal window” may refer generally to a UI element that is displayed on top of a main window. Depending on the desired implementation, a slide-out panel may be used instead of a modal. Slide-out panels are similar to modals in that they are designed to draw a user's attention but it is not necessary to dismiss the slide-out panels in order to continue interacting with the underlying content.

For example, client system 110 may generate example UI view 700 in FIG. 7 to include modal 710 in response to detecting a click interaction with UI element 620 and/or tooltip 630 in the example in FIG. 6. Tooltip 630 displays message=“<ATT-j=Last backup> configured for <OBJ-i=Chicago> location was failed on <date> at <time>. Click to configure backup.” In practice, in response to detecting the click interaction, client system 110 may generate and send a query with a parameter identifying pair=(OBJ-i, ATT-j) to visualization manager 120. This way, example UI view 700 may be generated based on a query response from visualization manager 120. Example modal 710 may be generated based on pair=(OBJ-i, ATT-j) to enable configuration of more granular parameter(s) associated with ATT-j, such as fully qualified domain name (FQDN) or IP address, protocol, port, directory path, username, password, etc. The set of parameter(s) may change depending on pair=(OBJ-i, ATT-j).

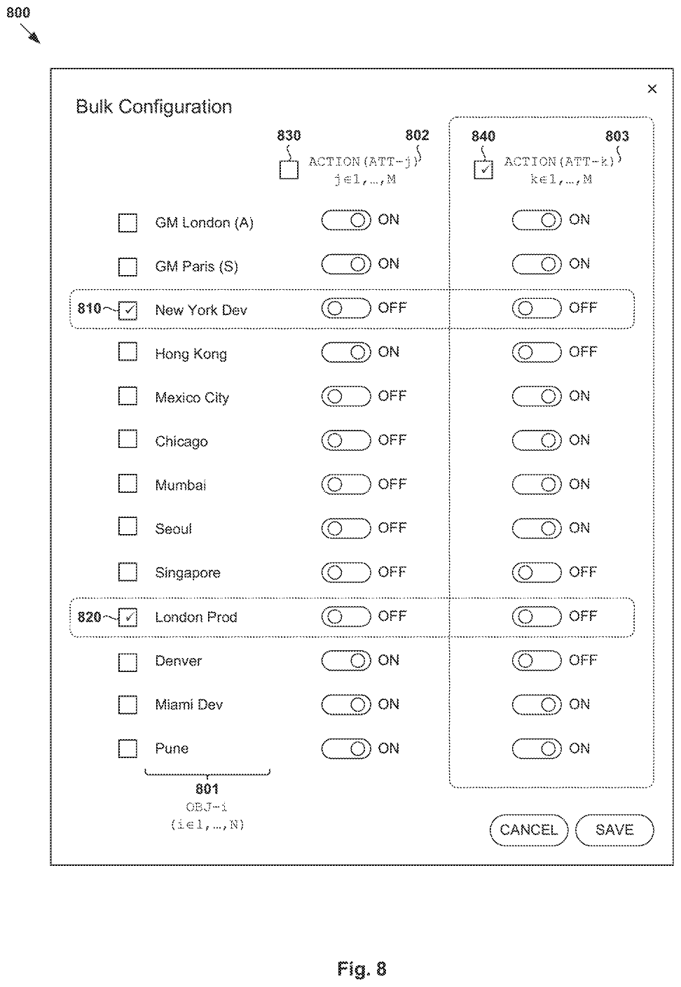

FIG. 8 is a schematic diagram illustrating fifth example UI view 800 to facilitate bulk configuration for multiple objects and/or multiple attributes. Example UI view 800 may include (a) first header information identifying multiple objects (see 801) and (b) second header information identifying multiple attributes (see 802-803). For example, ACTION (ATT-j) may denote a first configuration action associated with ATT-j=synchronization status, such as perform resynchronization for object(s) with a failed status. In another example, ACTION (ATT-k) may denote a second configuration action associated with ATT-k=Last Backup, such as configure backup, etc.

Example UI view 800 may include an interactive UI element (e.g., toggle button) to facilitate enable or disable a particular configuration for a object-attribute pair. Checkbox 810/820 next to a particular OBJ-i (e.g., New York Dev or London Prod) may be checked to select or enable a first bulk action associated with multiple attributes for the OBJ-i (i.e., at least some of but not necessarily all attributes in second set 220 in FIG. 2). Checkbox 830 next to a particular ACTION (ATT-k) may be checked to select or enable a second bulk action associated with a particular attribute (e.g., Last Backup) for multiple objects (i.e., at least some of but not necessarily all objects in first set 210 in FIG. 1). The example in FIG. 8 may be implemented to further improve efficiency and reduce the number of clicks required during configuration.

Using examples of the present disclosure, UI views may be generated to provide users 113 with a quick overview of the risks present in a network environment and the correlation between objects and attributes associated with the risks. This helps to bring users' attention to existing and potential problem areas more quickly, allowing users to drill down into those specific areas and take corrective actions. Users may simply choose to hover across the nodal points and look for noticeable audio and visual feedback to spot a particular risk.

### Additional Use Cases

Examples of the present disclosure may be implemented in any suitable visualization scenarios that require a switch from a conventional grid or tabular layout to fretboard-style visualization. It should be understood that examples of the present disclosure may be implemented for other types of object-attribute pair, and not limited to the examples in FIGS. 1-9.

### Example Network Environment

Example objects within a data center (e.g., 141, 151 in FIG. 1) will be described using FIG. 9, which is a schematic diagram illustrating example network environment 900 for which network status visualization for monitoring and configuration may be performed. Depending on the desired implementation, network environment 900 may include additional and/or alternative components than that shown in FIG. 1. Here, network environment 900 may be a software-defined networking (SDN) environment that includes multiple objects, including hosts 110A-C that are inter-connected via physical network 904. In practice, SDN environment 900 may include any number of hosts (also known as a “host computers”, “host devices”, “physical servers”, “server systems”, “transport nodes,” etc.), where each host may be supporting tens or hundreds of virtual machines (VMs).

Each host 910A/910B/910C may include suitable hardware 912A/912B/912C and virtualization software (e.g., hypervisor-A 914A, hypervisor-B 914B, hypervisor-C 914C) to support various VMs. For example, hosts 910A-C may support respective VMs 931-936 (see also FIG. 9). Hypervisor 914A/914B/914C maintains a mapping between underlying hardware 912A/912B/912C and virtual resources allocated to respective VMs. Hardware 912A/912B/912C includes suitable physical components, such as central processing unit(s) (CPU(s)) or processor(s) 920A/920B/920C; memory 922A/922B/922C; physical network interface controllers (NICs) 924A/924B/924C; and storage disk(s) 926A/926B/926C, etc.

Virtual resources are allocated to respective VMs 931-936 to support a guest operating system (OS) and application(s). For example, VMs 931-936 support respective applications 941-946 (see “APP1” to “APP6”). The virtual resources may include virtual CPU, guest physical memory, virtual disk, virtual network interface controller (VNIC), etc. Hardware resources may be emulated using virtual machine monitors (VMMs). For example in FIG. 9, VNICs 951-956 are virtual network adapters for VMs 931-936, respectively, and are emulated by corresponding VMMs (not shown for simplicity) instantiated by their respective hypervisor at respective host-A 910A, host-B 910B and host-C 910C. The VMMs may be considered as part of respective VMs, or alternatively, separated from the VMs. Although one-to-one relationships are shown, one VM may be associated with multiple VNICs (each VNIC having its own network address).

Although examples of the present disclosure refer to VMs, it should be understood that a “virtual machine” running on a host is merely one example of a “virtualized computing instance” or “workload.” A virtualized computing instance may represent an addressable data compute node (DCN) or isolated user space instance. In practice, any suitable technology may be used to provide isolated user space instances, not just hardware virtualization. Other virtualized computing instances may include containers (e.g., running within a VM or on top of a host operating system without the need for a hypervisor or separate operating system or implemented as an operating system level virtualization), virtual private servers, client computers, etc. Such container technology is available from, among others, Docker, Inc. The VMs may also be complete computational environments, containing virtual equivalents of the hardware and software components of a physical computing system.

Although explained using VMs 931-936, it should be understood that SDN environment 900 may include other virtual workloads, such as containers, etc. As used herein, the term “container” (also known as “container instance”) is used generally to describe an application that is encapsulated with all its dependencies (e.g., binaries, libraries, etc.). For example, container technologies may be used to run various containers inside respective VMs 931-936. Containers are “OS-less”, meaning that they do not include any OS that could weigh 10s of Gigabytes (GB). This makes containers more lightweight, portable, efficient and suitable for delivery into an isolated OS environment. Running containers inside a VM (known as “containers-on-virtual-machine” approach) not only leverages the benefits of container technologies but also that of virtualization technologies. The containers may be executed as isolated processes inside respective VMs.

The term “hypervisor” may refer generally to a software layer or component that supports the execution of multiple virtualized computing instances, including system-level software in guest VMs that supports namespace containers such as Docker, etc. Hypervisors 914A-C may each implement any suitable virtualization technology, such as VMware ESX® or ESXi™ (available from VMware, Inc.), Kernel-based Virtual Machine (KVM), etc. The term “packet” may refer generally to a group of bits that can be transported together, and may be in another form, such as “frame,” “message,” “segment,” etc. The term “traffic” may refer generally to multiple packets. The term “layer-9” may refer generally to a link layer or media access control (MAC) layer; “layer-3” to a network or Internet Protocol (IP) layer; and “layer-4” to a transport layer (e.g., using Transmission Control Protocol (TCP), User Datagram Protocol (UDP), etc.), in the Open System Interconnection (OSI) model, although the concepts described herein may be used with other networking models.

Hypervisor 914A/914B/914C implements virtual switch 915A/915B/915C and logical distributed router (DR) instance 917A/917B/917C to handle egress packets from, and ingress packets to, corresponding VMs. To protect VMs 931-936 against security threats caused by unwanted packets, hypervisors 914A-C may implement firewall engines to filter packets. For example, distributed firewall (DFW) engines 971-976 (see “DFW1” to “DFW6”) are configured to filter packets to, and from, respective VMs 931-936 according to firewall rules. In practice, network packets may be filtered according to firewall rules at any point along a datapath from a VM to corresponding physical NIC 924A/924B/924C. For example, a filter component (not shown) is incorporated into each VNIC 951-956 that enforces firewall rules that are associated with the endpoint corresponding to that VNIC and maintained by respective DFW engines 971-976.

Through virtualization of networking services in SDN environment 900, logical networks (also referred to as overlay networks or logical overlay networks) may be provisioned, changed, stored, deleted and restored programmatically without having to reconfigure the underlying physical hardware architecture. A logical overlay network may be formed using any suitable tunneling protocol, such as Virtual extensible Local Area Network (VXLAN), Stateless Transport Tunneling (STT), Generic Network Virtualization Encapsulation (GENEVE), etc. For example, VXLAN is a layer-9 overlay scheme on a layer-3 network that uses tunnel encapsulation to extend layer-9 segments across multiple hosts, which may reside on different layer 9 physical networks. Hypervisor 914A/914B/914C may implement virtual tunnel endpoint (VTEP) 919A/919B/919C to perform encapsulation and decapsulation for packets that are sent via a logical overlay tunnel that is established over physical network 904.

In practice, logical switches and logical routers may be deployed to form logical networks in a logical network environment. The logical switches and logical DRs may be implemented in a distributed manner and can span multiple hosts. For example, logical switches that provide first-hop, logical layer-9 connectivity (i.e., an overlay network) may be implemented collectively by virtual switches 915A-C and represented internally using forwarding tables 916A-C at respective virtual switches 915A-C. Forwarding tables 916A-C may each include entries that collectively implement the respective logical switches. VMs that are connected to the same logical switch are said to be deployed on the same logical layer-9 segment. Further, logical DRs that provide logical layer-3 connectivity may be implemented collectively by DR instances 917A-C and represented internally using routing tables 918A-C at respective DR instances 917A-C. Routing tables 918A-C may each include entries that collectively implement the respective logical DRs. As used herein, the term “logical network element” may refer generally to a logical switch, logical router, logical port, etc.

Packets may be received from, or sent to, each VM via an associated logical port. For example, logical switch ports 961-966 (see “LP1” to “LP6”) are associated with respective VMs 931-936. Here, the term “logical port” or “logical switch port” may refer generally to a port on a logical switch to which a virtualized computing instance is connected. A “logical switch” may refer generally to a software-defined networking (SDN) construct that is collectively implemented by virtual switches 915A-C in FIG. 9, whereas a “virtual switch” may refer generally to a software switch or software implementation of a physical switch. In practice, there is usually a one-to-one mapping between a logical port on a logical switch and a virtual port on virtual switch 915A/915B/915C. However, the mapping may change in some scenarios, such as when the logical port is mapped to a different virtual port on a different virtual switch after migration of a corresponding virtualized computing instance (e.g., when the source host and destination host do not have a distributed virtual switch spanning them).

In a data center with multiple tenants requiring isolation from each other, a multi-tier topology may be used. For example, a two-tier topology includes an upper tier-0 (T0) associated with a provider logical router (PLR) and a lower tier-1 (T1) associated with a tenant logical router (TLR). The multi-tiered topology enables both the provider (e.g., data center owner) and tenant (e.g., data center tenant) to control their own services and policies. Each tenant has full control over its T1 policies, whereas common T0 policies may be applied to different tenants. A T0 logical router may be deployed at the edge of a geographical site to act as gateway between internal logical network and external networks, and also responsible for bridging different T1 logical routers associated with different data center tenants.

Further, a logical router may be a logical DR or logical service router (SR). A DR is deployed to provide routing services for VM(s) and implemented in a distributed manner in that it may span multiple hosts that support the VM(s). An SR is deployed to provide centralized stateful services, such as IP address assignment using dynamic host configuration protocol (DHCP), intrusion detection, load balancing, network address translation (NAT), etc. In practice, SRs may be implemented using edge appliance(s), which may be VM(s) and/or physical machines (i.e., bare metal machines). SRs are capable of performing functionalities of a switch, router, bridge, gateway, edge appliance, or any combination thereof. As such, a logical router may be one of the following: T1-DR, T1-SR (i.e., T1 gateway), TO-DR and TO-SR.

SDN manager 980 and SDN controller 982 are example network management entities that may be implemented using physical machine(s), VM(s), or both in SDN environment 900. One example of an SDN controller is the NSX controller component of VMware NSX® (available from VMware, Inc.). SDN controller 984 may be a member of a controller cluster (not shown for simplicity) that is configurable using SDN manager 980. For example, logical switches, logical routers, and logical overlay networks may be configured using SDN controller 984, SDN manager 980, etc. To send or receive control information, a local control plane (LCP) agent (not shown) on host 910A/910B/910C may interact with SDN controller 984 via control-plane channel 901/902/903 (shown in FIG. 9).

### Computer System

The above examples can be implemented by hardware (including hardware logic circuitry), software or firmware or a combination thereof. The above examples may be implemented by any suitable computer system, etc. The computer system may include processor(s), memory unit(s) and physical NIC(s) that may communicate with each other via a communication bus, etc. The computer system may include a non-transitory computer-readable medium having stored thereon instructions or program code that, when executed by the processor, cause the processor to perform processes described herein with reference to FIG. 1 to FIG. 9.

The techniques introduced above can be implemented in special-purpose hardwired circuitry, in software and/or firmware in conjunction with programmable circuitry, or in a combination thereof. Special-purpose hardwired circuitry may be in the form of, for example, one or more application-specific integrated circuits (ASICs), programmable logic devices (PLDs), field-programmable gate arrays (FPGAs), and others. The term ‘processor’ is to be interpreted broadly to include a processing unit, ASIC, logic unit, or programmable gate array etc.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or any combination thereof.

Those skilled in the art will recognize that some aspects of the embodiments disclosed herein, in whole or in part, can be equivalently implemented in integrated circuits, as one or more computer programs running on one or more computers (e.g., as one or more programs running on one or more computing systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure.

Software and/or to implement the techniques introduced here may be stored on a non-transitory computer-readable storage medium and may be executed by one or more general-purpose or special-purpose programmable microprocessors. A “computer-readable storage medium”, as the term is used herein, includes any mechanism that provides (i.e., stores and/or transmits) information in a form accessible by a machine (e.g., a computer, network device, personal digital assistant (PDA), mobile device, manufacturing tool, any device with a set of one or more processors, etc.). A computer-readable storage medium may include recordable/non recordable media (e.g., read-only memory (ROM), random access memory (RAM), magnetic disk or optical storage media, flash memory devices, etc.).

The drawings are only illustrations of an example, wherein the units or procedure shown in the drawings are not necessarily essential for implementing the present disclosure. Those skilled in the art will understand that the units in the device in the examples can be arranged in the device in the examples as described, or can be alternatively located in one or more devices different from that in the examples. The units in the examples described can be combined into one module or further divided into a plurality of sub-units.

What is claimed is:

1. A method for a computer system for network status visualization, wherein the method comprises:
obtaining status information associated with a set of multiple object-attribute pairs, wherein each object-attribute pair includes one of multiple objects in a network environment and one of multiple attributes associated with the multiple objects;
generating and displaying, on a display device of the computer system, a user interface (UI) view that includes an array of multiple interactive UI elements to display the status information associated with respective multiple object-attribute pairs;
in response to detecting a first interaction with a first interactive UI element from the array, updating the UI view to display and enable selection of a first action, wherein (a) the first interactive UI element is associated with a first object-attribute pair from the set, and (b) the first action is determined based on first status information associated with the first object-attribute pair; and
in response to detecting a second interaction with a second interactive UI element from the array, updating the UI view to display and enable selection of a second action, wherein (a) the second interactive UI element is associated with a second object-attribute pair from the set, and (b) the second action is determined based on second status information associated with the second object-attribute pair.

2. The method of claim 1, wherein updating the UI view comprises:
in response to detecting the first interaction in the form of a hover interaction with the first interactive UI element, updating the UI view to include visual feedback substantially adjacent to the first interactive UI element to specify (a) details associated with the first status information and (b) the first action.

3. The method of claim 2, wherein updating the UI view comprises:
updating the UI view to provide audio feedback based on the first status information along with the visual feedback.

4. The method of claim 1, wherein updating the UI view comprises:
determining the first action by mapping a risk level indicated by the first status information associated with the first object-attribute pair to the first action.

5. The method of claim 1, wherein the method further comprises:
in response to detecting the first interaction with the first interactive UI element, updating the UI view to display (a) a first line connecting the first interactive UI element to a first header identifying a particular object from the first object-attribute pair, and (b) a second line connecting the first interactive UI element to a second header identifying a particular attribute from the first object-attribute pair.

6. The method of claim 1, wherein the method further comprises:
in response to detecting a first selection of the first action, generating and displaying, on the display device, a further UI view to enable configuration associated with the first action.

7. The method of claim 1, wherein the method further comprises:
generating and displaying, on the display device, a further UI view to enable selection of (a) a first bulk action associated with at least some of the multiple attributes for a particular object, or (b) a second bulk action associated with a particular attribute for at least some of the multiple objects.

8. A non-transitory computer-readable storage medium that includes a set of instructions which, in response to execution by a processor of a computer system, cause the processor to perform a method of network status visualization, wherein the method comprises:
obtaining status information associated with a set of multiple object-attribute pairs, wherein each object-attribute pair includes one of multiple objects and one of multiple attributes associated with the multiple objects;
generating and displaying, on a display device of the computer system, a user interface (UI) view that includes an array of multiple interactive UI elements to display the status information associated with respective multiple object-attribute pairs;
in response to detecting a first interaction with a first interactive UI element from the array, updating the UI view to display and enable selection of a first action, wherein (a) the first interactive UI element is associated with a first object-attribute pair from the set, and (b) the first action is determined based on first status information associated with the first object-attribute pair; and
in response to detecting a second interaction with a second interactive UI element from the array, updating the UI view to display and enable selection of a second action, wherein (a) the second interactive UI element is associated with a second object-attribute pair from the set, and (b) the second action is determined based on second status information associated with the second object-attribute pair.

9. The non-transitory computer-readable storage medium of claim 8, wherein updating the UI view comprises:
in response to detecting the first interaction in the form of a hover interaction with the first interactive UI element, updating the UI view to include visual feedback substantially adjacent to the first interactive UI element to specify (a) details associated with the first status information and (b) the first action.

10. The non-transitory computer-readable storage medium of claim 9, wherein updating the UI view comprises:
updating the UI view to provide audio feedback based on the first status information along with the visual feedback.

11. The non-transitory computer-readable storage medium of claim 8, wherein updating the UI view comprises:
determining the first action based on the first status information in the form of a risk level associated with the first object-attribute pair.

12. The non-transitory computer-readable storage medium of claim 8, wherein the method further comprises:
in response to detecting the first interaction with the first interactive UI element, updating the UI view to display (a) a first line connecting the first interactive UI element to a first header identifying a particular object from the first object-attribute pair, and (b) a second line connecting the first interactive UI element to a second header identifying a particular attribute from the first object-attribute pair.

13. The non-transitory computer-readable storage medium of claim 8, wherein the method further comprises:
in response to detecting a first selection of the first action, generating and displaying, on the display device, a further UI view to enable parameter configuration associated with the first action.

14. The non-transitory computer-readable storage medium of claim 8, wherein the method further comprises:
generating and displaying, on the display device, a further UI view to enable selection of (a) a first bulk action associated with at least some of the multiple attributes for a particular object, or (b) a second bulk action associated with a particular attribute for at least some of the multiple objects.

15. A computer system, comprising:
a display device; and
a web browser engine to:
obtain status information associated with a set of multiple object-attribute pairs, wherein each object-attribute pair includes one of multiple objects in a network environment and one of multiple attributes associated with the multiple objects;
generate and display, on the display device, a user interface (UI) view that includes an array of multiple interactive UI elements to display the status information associated with respective multiple object-attribute pairs;
in response to detecting a first interaction with a first interactive UI element from the array, update the UI view on the display device to display and enable selection of a first action, wherein (a) the first interactive UI element is associated with a first object-attribute pair from the set, and (b) the first action is determined based on first status information associated with the first object-attribute pair; and
in response to detecting a second interaction with a second interactive UI element from the array, update the UI view on the display device to display and enable selection of a second action, wherein (a) the second interactive UI element is associated with a second object-attribute pair from the set, and (b) the second action is determined based on second status information associated with the second object-attribute pair.

16. The computer system of claim 15, wherein the web browser engine is to update the UI view by performing the following:
in response to detecting the first interaction in the form of a hover interaction with the first interactive UI element, update the UI view to include a tooltip substantially adjacent to the first interactive UI element to specify (a) details associated with the first status information and (b) the first action.

17. The computer system of claim 16, wherein the web browser engine is to update the UI view by performing the following:
update the UI view to provide audio feedback based on the first status information along with the visual feedback.

18. The computer system of claim 15, wherein the web browser engine is to update the UI view by performing the following:
determine the first action based on the first status information in the form of a risk level associated with the first object-attribute pair.

19. The computer system of claim 15, wherein the web browser engine is further to:
in response to detecting the first interaction with the first interactive UI element, update the UI view to display (a) a first line connecting the first interactive UI element to a first header identifying a particular object from the first object-attribute pair, and (b) a second line connecting the first interactive UI element to a second header identifying a particular attribute from the first object-attribute pair.

20. The computer system of claim 15, wherein the web browser engine is further to:
in response to detecting a first selection of the first action, generate and display, on the display device, a further UI view to enable parameter configuration associated with the first action.

21. The computer system of claim 15, wherein the web browser engine is further to:
generate and display, on the display device, a further UI view to enable selection of (a) a first bulk action associated with at least some of the multiple attributes for a particular object, or (b) a second bulk action associated with a particular attribute for at least some of the multiple objects.
